(19) United States
(12) Patent Application Publication
(10) Pub. No.: US 2021/0027175 A1
(43) Pub. Date: Jan. 28, 2021

(54) CONTEXT-INFUSED ONTOLOGY FOR KNOWLEDGE MODELS

(71) Applicant: BAE SYSTEMS Information and Electronic Systems Integration Inc., Nashua, NH (US)

(72) Inventors: Nicholas R. Jenson, Poway, CA (US); Kari Perry, Reston, VA (US); Nicholas M. Swenson, Escondido, CA (US)

(21) Appl. No.: 16/523,144

(22) Filed: Jul. 26, 2019

(51) Int. Cl. G06N 5/02; G06F 16/36

(52) U.S. Cl. CPC G06N 5/022; G06F 16/367

(57) ABSTRACT

Techniques, systems, architectures, and methods for efficient and accurate intelligence gathering comprising extensions to Knowledge Modeling (KM) schema that allow for the capture of additional contextual parameters, allowing analysts to capture additional data and information capable of answering “Who, What, When, and Where” type questions with respect to an adversary's behavior and processes.

### FIELD OF THE DISCLOSURE

The following disclosure relates generally to intelligence gathering and, more specifically, to systems and methods of Knowledge Modeling (KM), which is also herein referred to as Activity Modelling (AM).

### BACKGROUND

We live in a world of ever-increasing data. Sensors, satellites, cameras, radars, location aware devices, social media, and other devices and systems all contribute to the vast amount of data containing potentially useful intelligence information that is created every day. To help put the sheer volume of data into perspective, as of 2012, more than 90 percent of the stored data in the world had been created in the previous 2 years. While the huge amount of data available to the Intelligence Community (IC) might be seen as a boon to them, providing granular information about people, places, things and activities, its sheer quantity makes it difficult to work with in a timely manner, which is critical to ensuring that actionable intelligence is in fact acted on before the time for doing so has passed.

The IC relies primarily upon analysts to turn information, i.e. data, into actionable intelligence. Historically, the IC organized and disseminated information and intelligence based on the organization that produced it. Retrieving all available information about a person, place, or thing was primarily performed by going to the individual repository of each data producer and required an understanding of the sometimes unique naming conventions used by the different data producers to retrieve that organization's information or intelligence about the same person, place, or thing. Consequently, analysts could conceivably omit or miss important information or erroneously assume gaps existed where they did not.

Given the vast amount of data that must be sifted through, analysts using these historical systems and methods face an uphill battle against the challenges of the Four V's, i.e. variety, volume, velocity and veracity. The current model of individual analysts working alone to sift through stockpiles of data within stove-piped systems, systems that have the potential to share data or functionality with other systems, but which do not do so, is no longer sufficient or efficient. As the amount of data is only expected to increase over time and the present intelligence budget is widely considered unsustainable, given current fiscal pressures, and yet inadequate considering the scope and scale of current and future operational requirements, the way in which analysts transform that data into intelligence must change to keep up while dealing with fiscal realities.

What is needed, therefore, are systems and methods that allow the IC to transform vast quantities of raw data into actionable intelligence in a timely and cost-effective manner.

### SUMMARY

Streamlining and automating the connection of relevant data, with individual pieces of data being herein referred to as data objects, to contextually rich knowledge models using probabilistic relational learning techniques provides opportunities for more advanced, model-driven collection and enterprise level collection orchestration activities. Current model-driven collection efforts, however, are not scalable due to the amount of manual effort, time, and rigor required and only subjective knowledge with manual connections to limited supporting data. The approaches and systems disclosed herein, by evaluating empirical knowledge with automated connections to a full range of supporting data, is scalable, allowing the IC to transform vast quantities of raw data into actionable intelligence in a timely and cost-effective manner that will remain viable as the amount of data to be handled increases.

Knowledge Modeling (KM) is a technical solution that allows for the documentation of multi-faceted knowledge about adversary behavior. The concept of Knowledge Modeling, or activity knowledge capture, is focused on eliciting and documenting tacit knowledge in a systematic way.

Current knowledge modeling efforts endeavor to gather tacit knowledge about adversary activities and behavior from analytic subject matter experts. While the goal has been to elicit and document tacit knowledge, the reality is that models are generalized and made up of explicit knowledge—not tacit. The two main problems in the current approach are the lack of ability to capture knowledge variations without building entirely separate models and the enormous amount of time that it takes to construct individual models. To simplify, it is exceptionally difficult to convey relevant context in a way that doesn't require exponential effort for each variable.

Contextually relevant knowledge about adversary behavior is currently embedded into the model, if it is documented at all. This engrained information, in the form of free text, makes separation of foundational knowledge from contextually important variables unfeasible. Furthermore, the embedding of contextual variables as free text prevents valuable application of probabilistic mathematical approaches and machine learning approaches from providing machine aided support in the construction and refinement of knowledge models.

Said another way, current construction of knowledge graphs via Knowledge Modeling lacks the multi-faceted context needed to capture a robust understanding of a complex issue, leverage other knowledge graphs, and capitalize on machine-aided technologies. By focusing on defining context parameters that not only aide in the tacit knowledge elicitation, but provide mechanisms to support the environment for advanced applications of technology, such as probabilistic relational learning and other machine learning techniques, the shortcomings of current Knowledge Modeling techniques and systems can be overcome.

Knowledge Modeling techniques disclosed herein define Knowledge Models (KMs) to allow for the capture of contextual parameters. This allows analysts to better capture data and information capable of answering “Who, What, When, and Where” type questions with respect to an adversary's behavior and processes. The contextual parameters include Identity, Spatial, Temporal, Activity, and Resource contexts and can be further aligned to any domain-specific ontology classes as needed.

Implementations of the techniques discussed above may include a method or process, a system or apparatus, a kit, or computer software stored on a computer-accessible medium. The details or one or more implementations are set forth in the accompanying drawings and the description below. Other features will be apparent from the description and drawings, and form the claims.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is schematic showing an Knowledge Modeling (KM) workspace having extended context ontology classes, in accordance with embodiments of the present disclosure;

FIG. 2A is a table representative of a prior art data model;

FIG. 2B is a table representative of a data model in accordance with embodiments of the present disclosure;

FIG. 3A is a prior art model;

FIG. 3B is a model in accordance with embodiments of the present disclosure;

FIG. 4 is an example of context recommendations in accordance with embodiments of the present disclosure;

FIG. 5A is an example of interchangeable contexts, in accordance with embodiments of the present disclosure; and

FIG. 5B is a further example of interchangeable contexts, in accordance with embodiments of the present disclosure.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

Merriam-Webster defines context as the interrelated conditions in which something exists or occurs. From a computational standpoint, Anind K. Dey states that “Context is any information that can be used to characterize the situation of interest.” Dey, A. K. (2001). Understanding and Using Context. Human-Computer Interaction Institute, 10. For the purposes of this effort, we leverage both definitions in our approach to facilitate elicitation and advance construction of knowledge graphs.

The 5 W's (Who, What, When, Where, Why) and How are the building blocks for gathering information to communicate, collaborate, and solve problems; therefore, they form the base structure by which to understand and define context parameters in knowledge models, in accordance with embodiments of the present disclosure. To capture these context parameters explicitly during model creation, there must be a cooperative interplay among the analyst, the user interface, and back end systems that monitor user input, make contextually relevant suggestions, and guide the elicitation and model creation process. The user experience is equally important to facilitating elicitation as the context parameters. Intuitive visualizations and streamlining of workflows are also important to fully capture multi-faceted, tacit knowledge.

The current knowledge modeling ontology and data model has no provisions for the capture and exploitation of explicit context. However, in embodiments of the present disclosure, this ontology is extended to include the necessary context-specific ontology structure required to facilitate the elicitation and useful capture of context within knowledge models, and to build a foundation to support analytics to exploit it.

Said another way, existing Knowledge Modeling (KM) solutions are limited in the amount of contextual information that can be captured as part of a Knowledge Model (KM). The systems and methods disclosed herein, which may be referred to as contextual ontology, can be used in various forms to contextualize various types of data. By using the systems and methods disclosed herein, analysts are able to document the identities and actors involved, any relevant geospatial and temporal information, what events or activities have occurred or are expected to occur, and what kind of resources, materials, equipment, etc. are involved. Having this additional knowledge allows analysts to ask complex questions, such as: “What other models is a particular identity or resource involved with?” or “What other adversary behaviors/processes are coincident to a model that I'm supporting?” Analysts are also able to change the context of a model to compare and contrast their differences. For example: “What happens to my model if I change which identities (people or organizations) are involved?” or “How would this same model apply in a different geographic area?”

These benefits are achieved by extending the current ontology that defines Knowledge Models (KMs) to allow for the capture of additional contextual parameters. This allows analysts to capture additional data and information capable of answering “Who, What, When, and Where” type questions with respect to an adversary's behavior and processes.

In embodiments, the new contextual parameters include Identity, Spatial, Temporal, Activity, and Resource contexts and can be further aligned to any domain-specific ontology classes, as needed.

In embodiments, data is contextualized as it is pulled from a data repository.

More specifically, in embodiments, a general extensible ontology for modeling context allows for the capture and exploitation of explicit context. To extend the ontology, relevant classes in domain-specific ontologies are mapped as subclasses to the appropriate, high-level context class. In this ontology, context is represented by five classes aligned with the concepts of Who, What, When, and Where underneath a general parent class of Context itself. The context of “What” is further divided into Activity and Resource classes. The following is a brief overview of the classes of embodiments of the present disclosure:
IdentityContext: Aligned with Who, comprised of person or organization entities and properties;
SpatialContext: Aligned with Where, comprised of place entities, geo locations, and environmental parameters;
TemporalContext: Aligned with When, comprised of temporal entities (events), dates, and relative times (before, after);
ActivityContext: Aligned with What, comprised of event entities and activity entities; and
ResourceContext: Aligned with What, comprised of additional entities and materials associated with an element of a knowledge model.

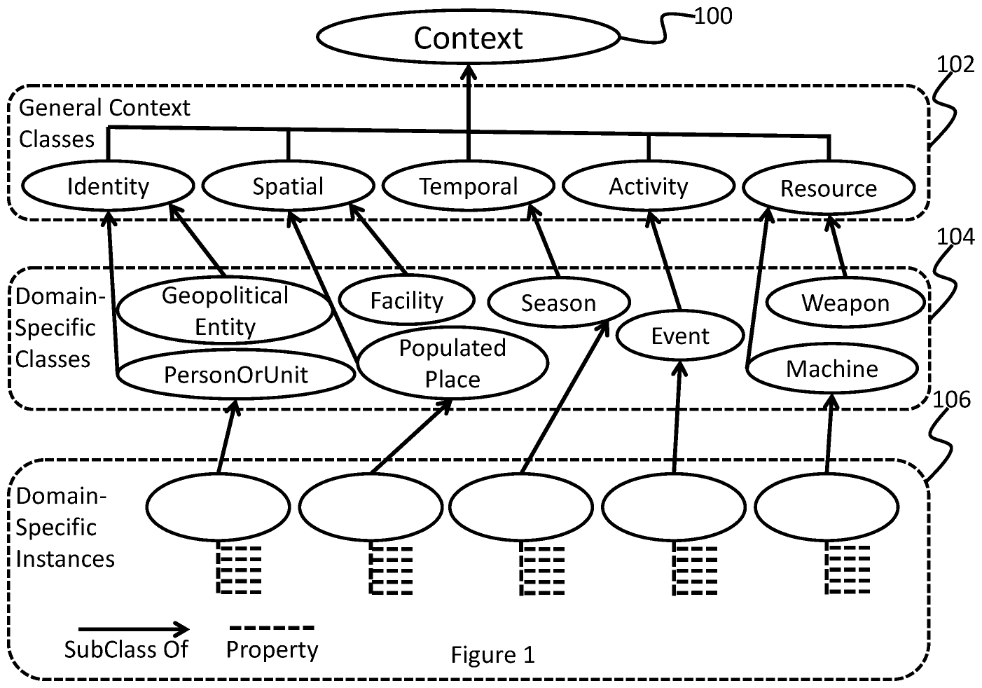

FIG. 1 schematically describes an embodiment in which ontology is organized hierarchically, with the general context classes 102 of Identity, Spatial, Temporal, Activity, and Resource one level below the Context 100 concept class. Below the general context classes 102 are domain specific classes 104, which are more specific categories of information pertaining to the general context class under which they are organized. Lastly, domain-specific instances 106 provide specific information relevant to a domain-specific class under which it is hierarchically organized. In such embodiments, the particular depth of a subclass indicates the relative level of domain-specificity encoded by the contextual parameters and relationships defined within a given domain-specific ontology. While three levels are shown, more or less could be used without departing from the teachings provided herein.

By extending the Context ontology with the classes and properties of domain-specific ontologies (for example, National System for Geospatial Intelligence Enterprise Ontology (NEO), National System for Geospatial Intelligence Application Schema (NAS), Ontology of Engineering, Arabic Ontology, etc.), the relational schemas already defined in those ontologies are able to be leveraged. The domain-specific classes 102 and properties relevant to the contextual classes are identified and mapped accordingly.

In embodiments, each specific context class in the general ontology shares common properties with the top level Context concept class, such as label, object type, name, and so on, allowing it to be easily automatically processed. Additionally, each context class has a particular set of properties that are required to capture its specific category of context. For example, the Spatial Context class includes properties specific to location information, such as latitudes and longitudes or geometries. The end result of this arrangement is an ontology with sets of classes and properties organized into, in embodiments, the five context subclasses and class properties described above.

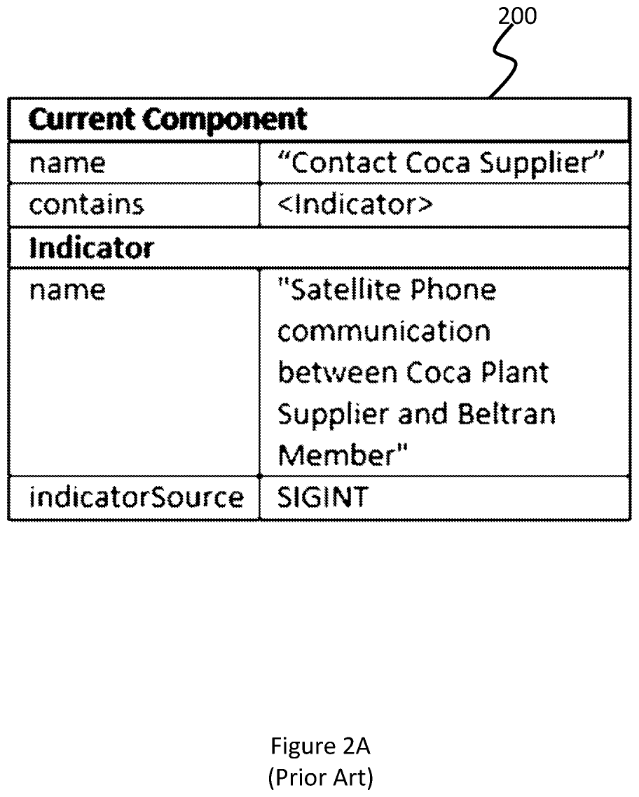

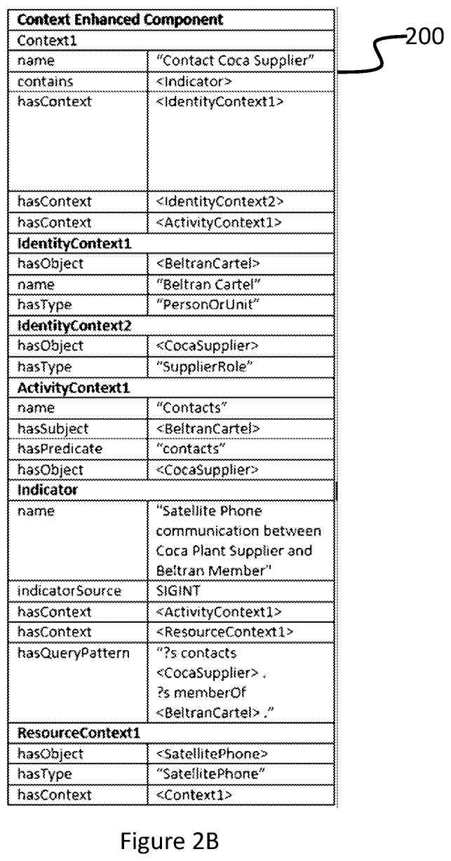

FIG. 2A shows an instance of a knowledge model component, or data object 200, as defined in the current ontology whereas FIG. 2B describes an ontology in accordance with embodiments of the present disclosure. More specifically, in the current ontology and consequent data model, the vast majority of contextual information is captured as free text, making it very difficult to exploit. In contrast, in the ontology of FIG. 2B, contextual information is captured explicitly by appropriate context class instances.

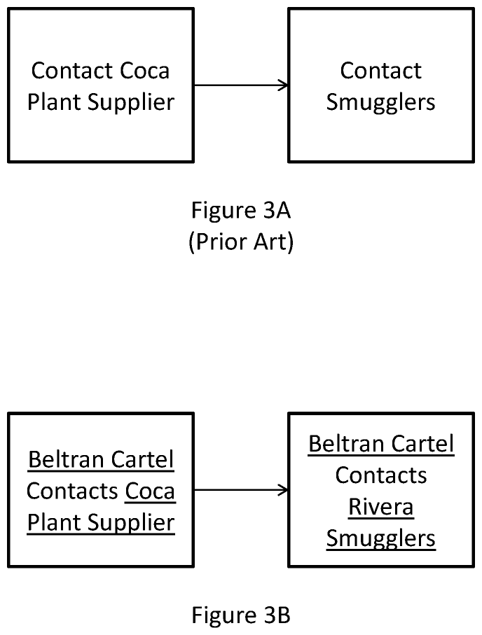

Now referring to FIGS. 3A and 3B, in embodiments, each element of context (e.g. Beltran Cartel and Rivera Smugglers) in the component is linked to a data object 200, which may describe an object, entity, or other information, residing in an external or third party data source and their relational attributes (e.g. contacts is a predicate in the ontology). Identifying context in this way enables the construction of query patterns, which may also be referred to as indicators, composed from these data entities and relationships to monitor for new data related to these entities with respect to the model component.

As used herein, the term “indicator” is used to refer to a query pattern that defines a specific activity or data that could provide evidence (i.e. an indication) to an analyst that a component (i.e. a step in a process) is happening (or that it has happened). For example, in a model concerning the Beltran Cartel's drug activities, one step, or component, in the model may be that they will meet with their materials supplier. An indicator for the “meet with supplier” component could be intelligence or data that members of the cartel were seen at the supplier's facility. In this case, the Model might be “Cartel Drug Activity,” the Component (or step in the model) might be “Meet with the Supplier,”, and Indicator(s) for meeting with the supplier (e.g. events whose occurrence would tend to make it more likely that the cartel met with the supplier) might be “Cartel members seen at the suppliers location OR Intercepted communication between cartel and supplier OR Confirmation from some knowledgeable human source that the meeting occurred.”

The ability to more systematically and purposefully gather knowledge from subject matter experts in a streamlined workflow, as described above, is a vast improvement to the way users are currently constructing models. In addition, meticulously handling contextual information for the construction and exploitation of a knowledge graph enables various technical applications to support the user and find new insights. The approaches and systems described herein provide immediate improvements to the current workflows and capabilities by easing the elicitation process, expediting the construction of knowledge models, and by providing the framework for future capability expansion.

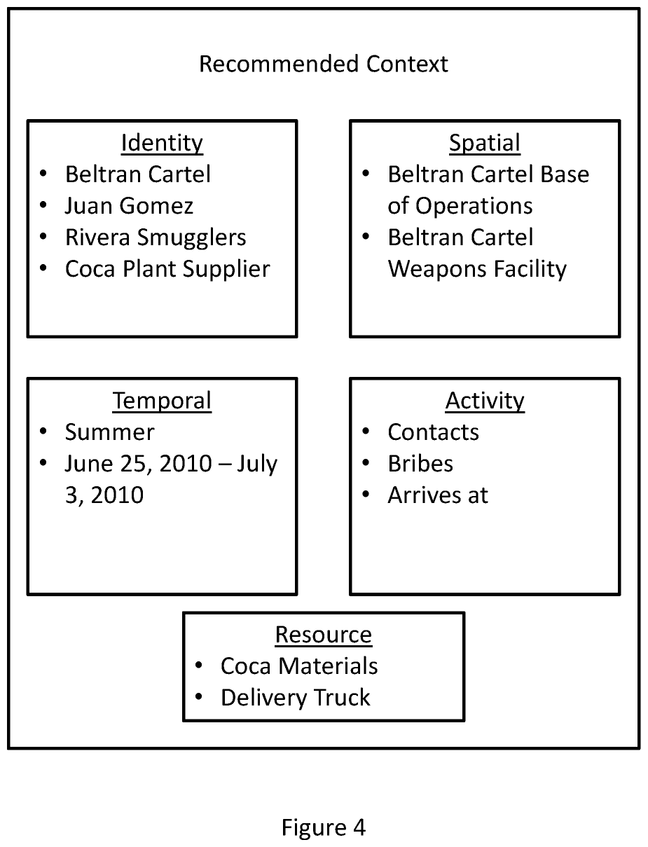

Furthermore, the structure of context parameters described herein eases the elicitation process by providing framing concepts for the subject matter expert to consider when attempting to document knowledge about an adversary's behavior. To truly elicit tacit knowledge, the knowledge a person doesn't realize that they possess, they must be prompted in a way that extracts that knowledge. Current models are elicited through multiple white boarding sessions, in person, with a knowledge modeling expert to document the first iteration of their model. From there, the subject matter experts are trained on how to expand the model that was built for them and/or create new models. In contrast, establishing a visualization and interactive system that leverages new contextual ontologies eliminates the need for facilitation sessions. Subject matter experts would instead rely upon system recommendations and prompts to navigate the model creation and modification process, as described in FIG. 4. These prompts also aid in the extraction of variables and dependencies building from a foundational concept of the analyst's knowledge, allowing for more robust documentation of tacit knowledge.

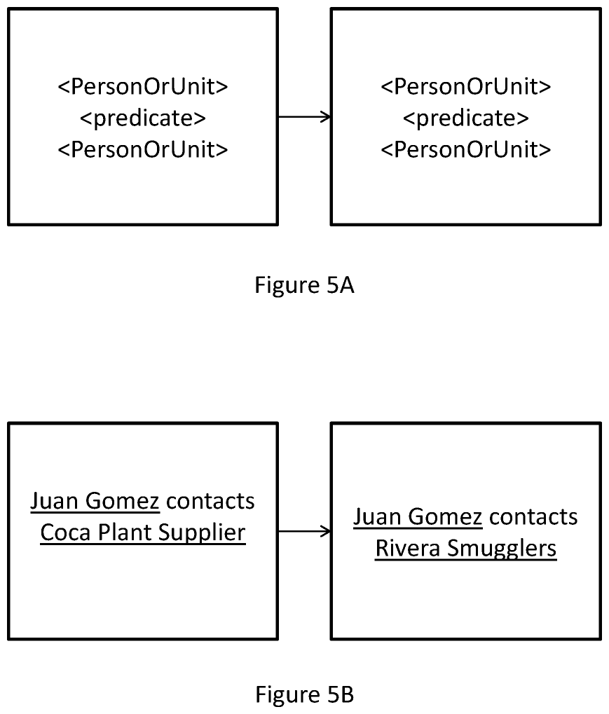

Now referring to FIGS. 5A and 5B, incorporating data and entities directly into model elements under specific context categories, in accordance with embodiments, simplifies changing the context of a model or any element therein down to exchanging the current data context object with another of similar type. For example a specific person referenced in the IdentityContext could be exchanged with any other specific person, category of person, or even an organization. To accomplish this in the current ontology, an analyst would have to inspect and edit multiple free text fields dispersed throughout the elements of the model, essentially creating a whole new model. Furthermore, by extracting a model's context, the structure of the model is left behind which can then be re-used as a template for rapid model creation.

Technical facilitation through appropriate structure and visualization accelerates the timeline for creation, modification, and collaboration on knowledge models. In addition to expediting construction of models, the structure of systems and approaches disclosed herein allow for rapid alignment of data and entities from third party data sources. Aligning data that contains information or metadata pertaining to real-world objects or entities (including relationships between entities and actions of those entities) provides an extensible framework that supports powerful new capabilities. In embodiments, each of these objects has properties and characteristics that describe what it is, a list of relationships to other objects, and a history of activities and observations that have been recorded across multiple tools or data sources. This richness of information can be leveraged to enable probabilistic learning and the application of advanced artificial intelligence techniques.

In summary, the approaches and systems disclosed herein expose significant future opportunities to extend and leverage knowledge graphs that enhance the analytic mission spaces. Automation for tradecraft support, knowledge base enrichment, and various machine learning techniques allow users to capitalize on the complex documentation of context variables of foundational knowledge.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

What is claimed is:

1. A knowledge or activity modelling system, comprising:
knowledge or activity models,
wherein the models provide for the capture of explicit contextual parameters relating to data objects through the use of a hierarchical schema comprising a plurality of general context classes, a plurality of domain-specific classes organized under each general context class, and a plurality of domain-specific instances, each comprising a plurality of data fields concerning various types of information pertinent to the domain-specific class under which the domain-specific instance is organized.

2. The system of claim 1 wherein the contextual parameters are designed to elicit information useful for answering questions of who, what, when, and where.

3. The system of claim 1 wherein the ontology is extensible.

4. The system of claim 1, wherein the contextual parameters comprise identity, spatial, temporal, activity, and resource contexts.

5. The system of claim 4 wherein said system is configured to allow users to discover data objects from internal and external sources and manually align those data objects to contextual categories.

6. The system of claim 1 wherein the modelling system is configured to pull data from existing repositories of data.

7. The system of claim 6 wherein the data is programmatically contextualized as it is pulled from a data repository.

8. A generalized, extensible ontology for modeling context that allows for the capture and exploitation of explicit context, the generalized, extensible ontology for modeling context comprising:
a hierarchical organization scheme comprising at least three levels of information, a first level in which information is organized by the general type of context that it provides, a second level in which information is organized by domain-specific classes, and a third level where information is organized by domain-specific instances,
wherein each level contains a plurality of groupings of information by context, and
wherein information in the second and third levels of the hierarchy is organized under one of the plurality of contextual groupings of information in the preceding level of the hierarchy.

9. The generalized, extensible ontology for modeling context of claim 8 wherein the information contained within the first level of the hierarchy is organized under one of five classes.

10. The generalized, extensible ontology for modeling context of claim 9 wherein the five classes of information are aligned with the concepts of Who, What, When, and Where.

11. The generalized, extensible ontology for modeling context of claim 10 wherein the context of “what” is divided into two classes that provide activity and resource context information.

12. The generalized, extensible ontology for modeling context of claim 11 wherein the remaining classes of information comprise identity, spatial, and temporal information, which align with the concepts of who, where, and what, respectively.

13. The generalized, extensible ontology for modeling context of claim 12 wherein the identity class comprises person or organization entities and properties, the spatial class comprises place entities, geo locations, and environmental parameters, the temporal class comprises temporal entities, such as events, dates, and relative times, such as before or after, the activity class comprises event entities and activity entities, and the resource class comprises additional entities and materials associated with an element of a knowledge model.

14. The generalized, extensible ontology for modeling context of claim 13 wherein information from each hierarchical class shares information with a top-level context concept class to which it relates.

15. The generalized, extensible ontology for modeling context of claim 14 wherein the shared information comprises metadata tags configured to allow for automatic processing of the information.

16. The generalized, extensible ontology for modeling context of claim 15 wherein each specific type of information provides a plurality of fields into which specific types of contextually relevant information can be input, wherein each field is referred to as an element of context.

17. The generalized, extensible ontology for modeling context of claim 16 wherein each element of context is linked to an object based production entity or class and their relational attributes.
